(19) United States
(12) Patent Application Publication
(10) Pub. No.: US 2026/0233854 A1
(43) Pub. Date: Aug. 13, 2026

(54) Aircraft Engine Opening Shield System with Installation Tool

(71) Applicant: SERIAS-LEE, LLC, WASHINGTON, NC (US)

(72) Inventors: LARRY THOMAS GRIFFIN, JR., WASHINGTON, NC (US); TONY LEE CHRISMON, Washington (NC); RALPH SAMUEL JARVIS, JR., BATH, NC (US)

(73) Assignee: SERIAS-LEE, LLC, Washington, NC (US)

(21) Appl. No.: 19/574,774

(22) Filed: Mar. 23, 2026

Related U.S. Application Data
(62) Division of application No. 18/487,163, filed on Oct. 16, 2023.

(51) Int. Cl. B64F 1/00

(52) U.S. Cl. CPC B64F 1/005

(57) ABSTRACT

A cover for use with aircraft equipment that covers the opening of an aircraft housing using two sets of moveable arms to secure the shield in place. A drive mechanism containing a nut that engages with the two sets of arms differently to allow movement of the two sets of arms at different rates and to allow one set of arms to move when another set of arms is locked in place. Both sets of arms as well as the hub assembly containing the drive mechanism are covered with a weather resistant fabric that prevents material from entering the housing. The arms are pivotably connected to a hub assembly housing that allows one end of the arms to pivot in a direction opposite the direction of movement of the opposing side of the same arm.

### CROSS-REFERENCE TO RELATED APPLICATIONS

This Application is a divisional of and claims the benefit of priority to United States non- provisional Application No. 18/487,163 filed on October 16, 2023. The content of United States Non-provisional Application No. 18/487,163 filed on October 16, 2023 is incorporated by reference in its entirety.

### BACKGROUND OF INVENTION

### a. Field of Invention

The present invention relates to aircraft, specifically in the technical field of ground support and accessories for aircraft such as covers used to protect sensitive aircraft components.

### b. Background Art

Modern aircraft have several sensitive components that need to be protected when the aircraft is out of service on the ground, stored or undergoing repair and/or maintenance. Among the sensitive components include, but not limited to, the nacelle/air inlet, engine exhaust ports, internal machinery of the engine assembly and other components that form the engine housing. In the prior art, there have been a number of protective covers or plugs designed to protect aircraft engine openings and the internal machinery of the engine assembly from intrusion by foreign bodies, including but not limited to, animals/insects, foreign objects, weather, and debris. Protection of these sensitive components is crucial to maintaining aircraft at proper operating capabilities when in flight. Failure to protect the engine openings associated with sensitive components can lead to significant and disabling damage to the aircraft.

Prior methods of protecting an aircraft engine traditionally required ladders or other ways to allow users to reach aircraft components located off of the ground in order to install a protective device. This proves to be unsafe for users as the risk of falling and other injuries rises when ground support personnel are working off the ground. The risk of damage to the aircraft also increases when personnel are working in an elevated position. In addition to the need for ladders or other ways to install prior art devices, the weight of the device also proves to be a factor that affects safety. Many devices are made from materials that are heavy and the extra mass increases the difficulty associated with installation. Prior art devices are also bulky in size and are hard to handle when the ground crews are working from ladders. This frequently means more than one person is required to safely install some ground support equipment (GSE).

Along with the method of installation, many devices require the use of fasteners, tethers, zippers, and other hardware to attach the device to the aircraft which can come into contact with and damage the aircraft surfaces. The fasteners also require the user to climb up and down the ladder to move the ladder to fully install the device, creating a threat to user safety and also a potential damage to the aircraft.

Traditionally, materials that are used to manufacture prior art devices have been made from vinyl material, nylon, temperature intolerant plastic, rubber and other materials that are not capable of sustaining the high temperatures needed to install these devices on an aircraft immediately after landing. Weather, chemical damage, and UV damage to the devices can also create a potential for holes in the material that allow animals, weather, debris, and other foreign objects to enter the engine opening, creating a threat to the sensitive components within the engine housing. Most material used to manufacture prior art allows for moisture to penetrate the device and enter the engine opening. Moisture can damage and corrode sensitive components within the engine housing, which in turn can prove to be catastrophic to the operation of the aircraft. Along with damage to the material of the prior art, most devices do not fully cover the engine opening, leaving gaps that allows animals/insects, weather, debris, and other foreign objects to enter the engine opening, again, creating a threat to the sensitive components within the engine housing.

There are other prior art devices that fully encase the outside of the engine thereby providing protection from animals, debris, and other foreign objects entering the engine opening but they still require users to use ladders or other unsafe methods to help with installation. Also, these devices are even bigger, bulkier, and heavier than devices that cover the opening of the engine so storage of said devices can be a challenge to users. By definition, these devices contact and attach to the outer surface of the engine assembly increasing the chances of damage to the aircraft.

### BRIEF SUMMARY OF THE INVENTION

The present invention is an aircraft engine inlet cover that is designed to fit the opening of the engine housing on an aircraft. The device can be securely installed without the need for ladders or other dangerous procedures. The method for installing the present invention is by an extendable pole that attaches to a port built into the handle of the cover hub. This method eliminates the need for ladders and other unsafe methods of installation by allowing a single user to install the device onto the engine from the ground.

The present invention is self-centering as is securely held onto the engine housing by a set of forward locking arms and a set of interior rear arms that act as interior locking devices. The extension of the arms centers the device in the engine inlet. The arms remove the need for fasteners, tethers, zippers, and other hardware to attach the device to the aircraft. The forward locking arm set has a leading-edge safety device that prevents the present invention from falling into the engine. The interior locking devices have touch points that have silicone bumpers to prevent damage to the interior wall of the nacelle. A predetermined install point for the forward locking arm set is displayed by a release of pressure on the turning mechanism. The present invention has a self-locking mechanism displayed by the interior locking devices once they reach the touch points around the inner diameter of the nacelle or engine inlet.

The hub of the present invention is indexed, i.e. it consists of interlocking, halves secured together with fasteners that are covered with reinforced fabric or other materials to prevent damage to the hub, the fabric or other materials, and the aircraft. The hub consists of the installation pole port assembly and the interior contains a specially designed lead screw, lock ring pressure thrust bearing system, and drive nut that drives the forward locking arms and the interior locking devices to open and close with ease. This internal mechanism drives the forward arms and internal locking arms at different rates, i.e. the locking ring or drive nut moves the forward locking arms into place and then while those arms stay locked in place, the drive nut continues turning moving the interior rear arms until they are locked in place. The forward locking arms traverse at a higher rate of speed than the interior locking arms. The hub is designed to prevent debris, animals/insects, weather, foreign objects, etc., from entering the inside of the engine. The forward locking arm set, and interior locking devices are made of lightweight carbon fiber or other materials and are attached to the hub by pivot points molded into the attaching locking arm socket which eliminates the need for pins or other attachment methods. The interior locking devices are made with a retaining cap assembly which allows the fabric to be securely held in place without damage to the fabric itself.

In preferred embodiments and the inventors' anticipated best mode, the hub, forward locking arm set, and interior locking devices of the present invention are all covered and protected by a high performance, 4-way stretch spacer fabric. The fabric is made of polyester, or similar materials, and is a breathable material. The hydrophobic properties of the fabric make it resistant to weather. The fabric is also chemical resistant and has a UV resistant finish and fire-resistant proof. The contact points of the fabric and the hub and arm sets are reinforced with abrasion resistant materials to prevent wear and tear, extending the life of the present invention. On the inner section of the present invention, the forward locking arm set, and interior locking devices are protected by pockets made from the same fabric and reinforcing materials to protect the engine from damage but also prevent the fabric from abrasion and wear and tear.

In addition, preferred embodiments and the anticipated best mode include a drive screw and installation pole port that are made of stainless steel or other hardened, non-corrosive materials.

The radial pattern of the present invention allows for customization to fit various sizes of engines. The shape of the invention is specifically designed to accommodate various engine housing openings, protecting the sensitive inner components of the engine from weather, animals/insects, foreign objects, debris, etc.

The installation port of the hub is actuated by an installation pole utilizing a keyed mechanism, i.e. the shape of the locking/unlocking mechanism on the installation pole is such that it will only fit into the installation pole port one way - there is no way to insert the installation pole into the installation pole port in the wrong direction and still operate the mechanism. The end of the installation pole that inserts into the engine shield hub is referred to as the locking end of the pole. The locking end of the installation pole has a head with an internal portion and an external portion. The internal portion features a cavity in which an external locking pin is pivotably connected to the internal portion, near the approximate center of the external locking pin. The locking pin therefore extends perpendicularly away from the internal portion of the pole head in two directions. The outer portion of the installation pole head features an insertion ring that inserts into the installation pole port on the hub assembly of the shield. The locking ring is rotatably attached to the outer portion of the pole head and rotates independently of the internal portion of the installation pole head. The installation pole is meant to be used by someone standing on the ground underneath the engine and as a result, the installation pole needs to be able to be operated with the pole at an angle to the installation pole port. Preferred embodiments and the inventors' anticipated best mode of the device use an installation port that has enough internal space or "play" in it to allow the locking ring to move in the port at an angle of up to 35 degrees. The pivoting external locking pin pivots up and down like a lever with the attachment point being the fulcrum while the user turns the installation pole inserted in the installation pole port. The up and down movement of the external locking pin prevents the locking pin from becoming bound in the port as the locking ring is turned while engaged with the installation port.

Preferred embodiments of the installation pole can also feature an internal locking pin that inserts into one or more locking grooves on the inside of the installation pole. The locking grooves are oriented such that they are substantially parallel to the longitudinal axis of the installation pole. Substantially and approximately in this disclosure means within 10 degrees of the stated measurement, i.e. substantially parallel means within 10 degrees of being perfectly parallel and substantially perpendicular means within 10 degrees of a right angle (80-110 degrees). A spring applies force to the locking head containing the internal locking pin and pushes the locking pin into the one or more locking grooves on the interior of the installation pole. The internal locking pin stays in one of these grooves until the user applies a downward force onto the locking end of the pole towards the rest of the installation pole. Then the user can rotate the locking end as the internal locking pin will be free from the locking groove. Preferred embodiments and the inventors' anticipated best mode use three locking grooves for a single locking pin to engage. One of the locking grooves prevents the rotation of the locking end or head of the pole in a counterclockwise direction; one prevents movement in the opposite direction and one groove is positioned such that when the locking pin engages that groove, the locking ring is in a "neutral position" which is the position in which the locking ring and the external locking pin are aligned.

To open and close the present invention, the port needs to be turned with the installation pole or can be turned by hand. The invention will fully collapse into a small cylindrical shape when not in use and can be secured shut by a strap affixed to the device. This allows for safe and easy storage on the aircraft.

### BRIEF DESCRIPTION OF THE SEVERAL VIEWS OF THE DRAWINGS

FIG. 1 is a perspective view of a preferred embodiment of the engine shield;

FIG. 2 is a front plan view of a preferred embodiment of the engine shield;

FIG. 3 is a perspective view of a preferred embodiment of the engine shield;

FIG. 4 is a cross-sectional side view of the same engine shield;

FIG. 5 is an exploded view of the hub assembly; FIG. 6 is another exploded view thereof;

FIG. 7A is a top plan view of the drive nut; FIG. 7B is a top plan view of the drive nut; FIG. 7C is a top plan view of the drive nut;

FIG. 8A is a perspective view of a contact point for a forward locking arm; FIG. 8B is a perspective view of a contact point for a interior rear arm;

FIG. 9A is a top plan view of the installation pole; FIG. 9B is a top plan view of the installation pole;

FIG. 9C is a side cross-sectional view thereof;

FIG. 9D is a side plan view of the installation pole;

FIG. 9E is a top cross-sectional view thereof; FIG. 9F is a top cross-sectional view thereof;

FIG. 10 is a side plan view of the installation pole prior to being inserted into the engine shield hub assembly;

FIG. 11 is a side plan view of the installation pole after to being inserted into the engine shield hub assembly;

FIG. 12 is a side cross-sectional view of the installation pole prior to being inserted into the engine shield hub assembly as shown in FIG. 10;

FIG. 13 is a side plan view of the installation pole after to being inserted into the engine shield hub assembly as shown in FIG. 11;

FIG. 14A is a front plan view of the engine shield hub assembly with the locking ring inserted in the neutral position;

FIG. 14B is a side cross-sectional view of the installation pole head inserted into the hub assembly while in the neutral position;

FIG. 15A is a front plan view of the engine shield hub assembly with the locking ring inserted in the installation or removal position

FIG. 15B is a side cross-sectional view of the engine shield hub assembly with the locking ring inserted in the installation or removal position;

FIG. 16A is a front plan view of the entry to the installation pole port; and

FIG. 16B is a side plan view thereof.

### DETAILED DESCRIPTION

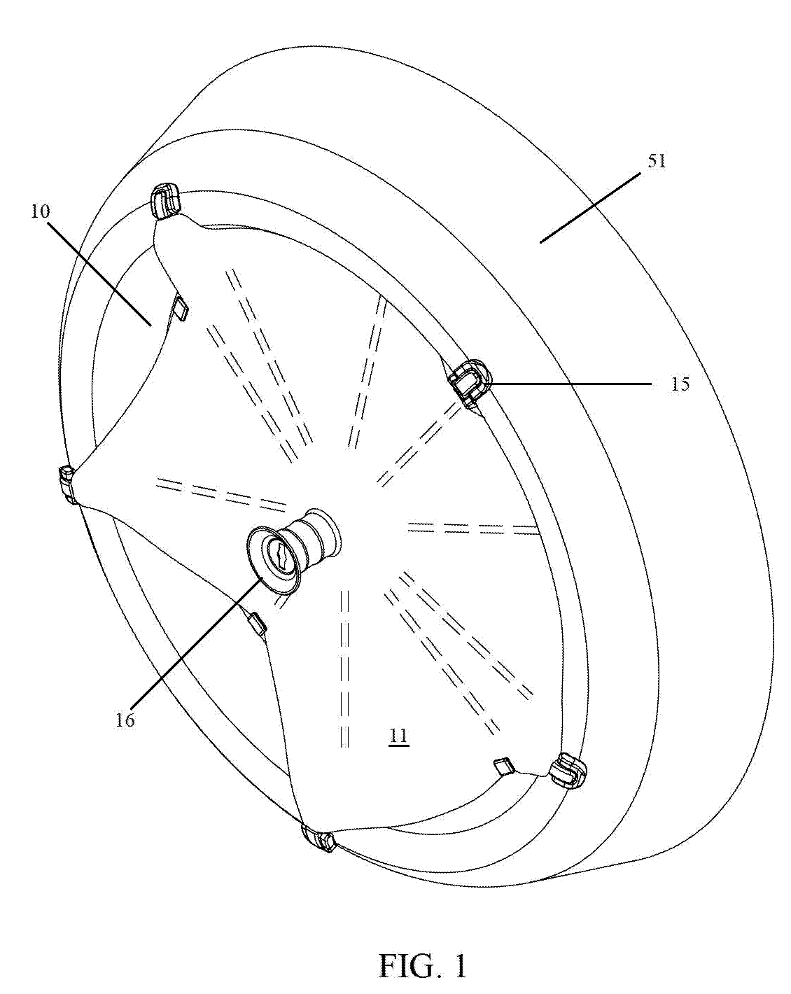

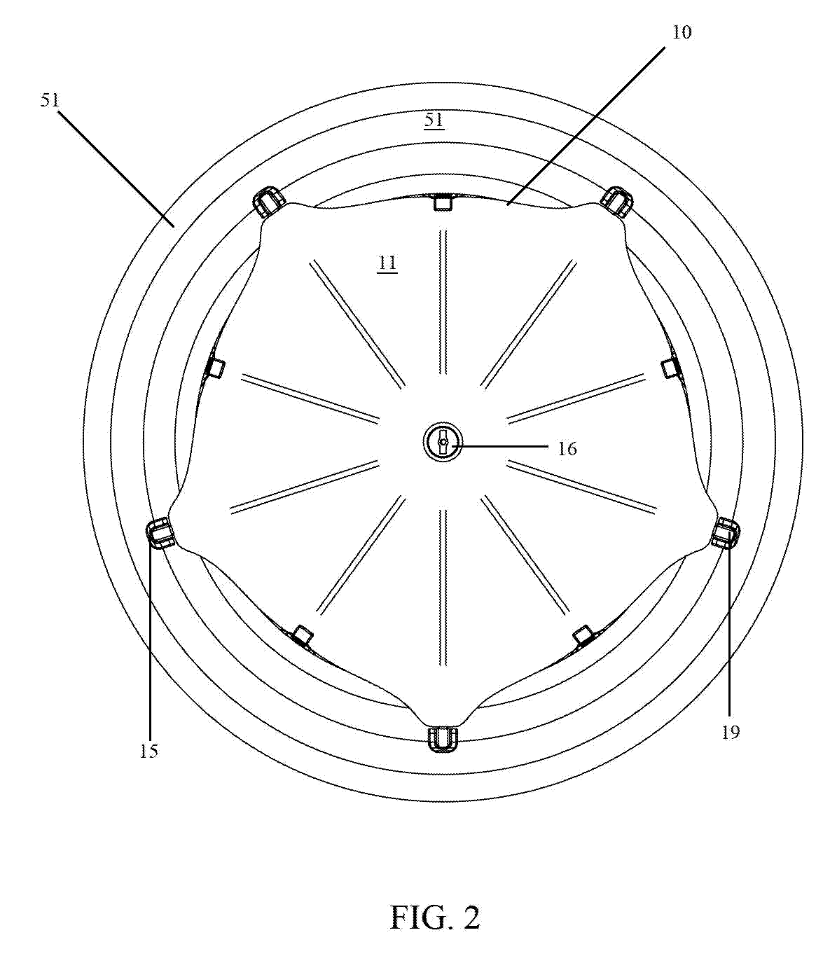

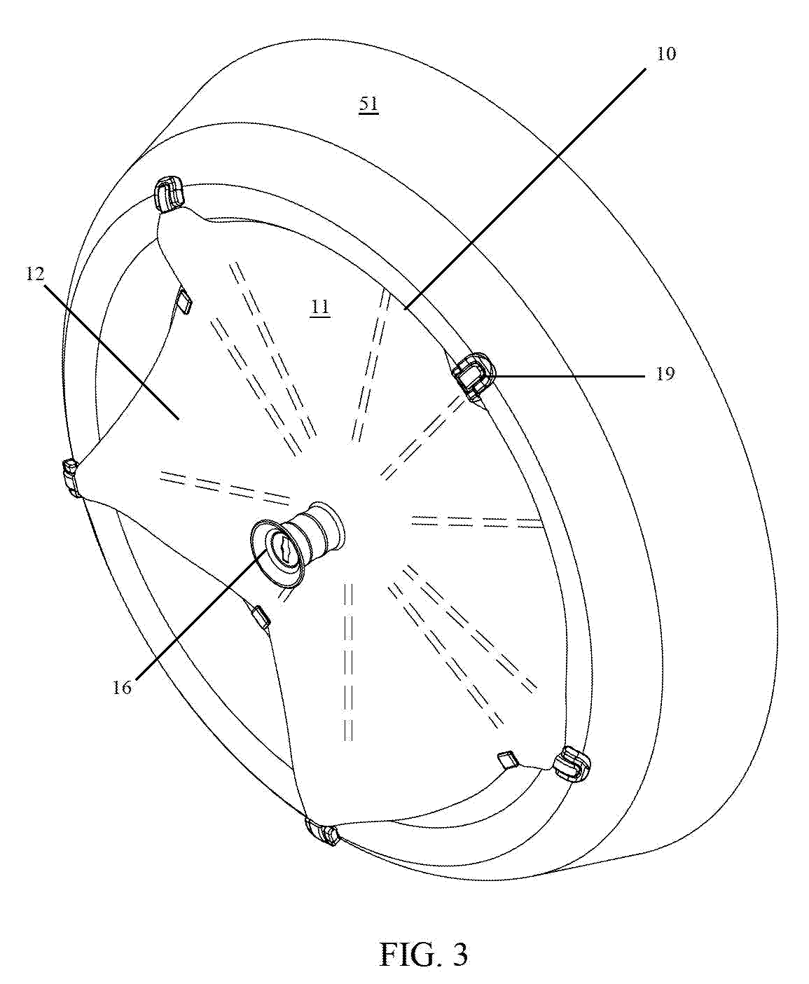

FIGS. 1-3 show perspective views of a preferred embodiment of the disclosed engine shield positioned inside of an engine. The shield 10, includes a shield cover 11 that covers an exterior side 12 of the shield 10. Beneath said shield cover 11 are a plurality of forward locking arms (not shown) and a plurality of interior rear arms (not shown). The arms 20, 25 are inserted into the cover 11 using pockets integrated into the shield cover 11 itself. As shown in FIG. 1, an end of each of the forward locking arms 20 terminates in a foot or bumper 19. It is the bumper 19 that physically contacts a portion of the aircraft, i.e. the outer surface of the engine housing 50 in this case. In preferred embodiments, the bumper 19 is made of silicone or some other material that is both durable, weatherproof and nonabrasive so that it does not damage the aircraft when in contact with it.

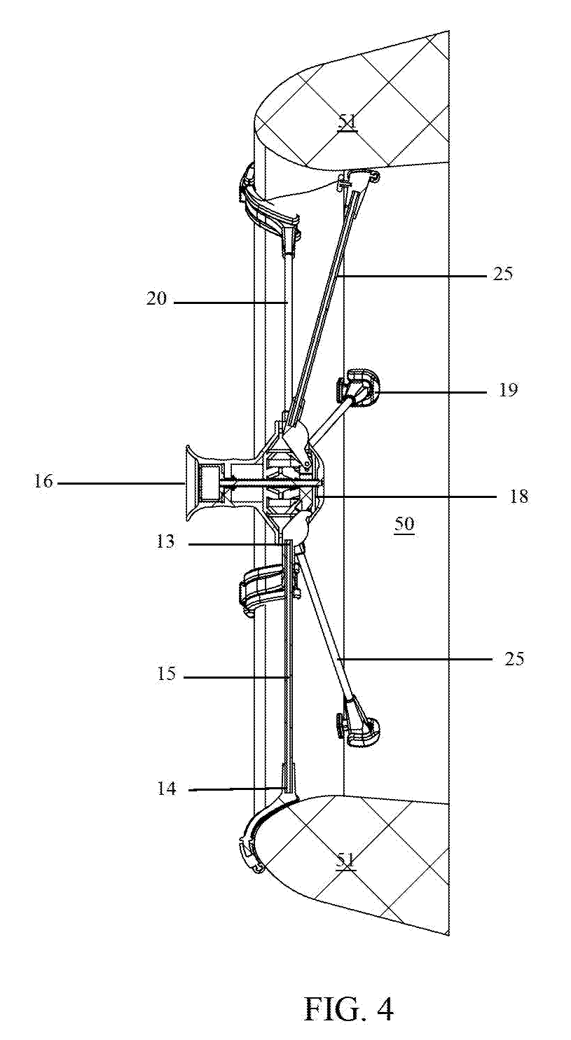

FIG. 4 shows a cross-sectional view of the same embodiment of the disclosed engine shield 10. As discussed above, the shield 10 has a set of forward locking arms 20 and a set of interior rear arms 25. Each of the arms 20, 25 has a first end 13, a second end 14 and a middle portion 15. The forward locking arms 20 contact the outer surface 51 of the engine housing 50 into which the shield has been inserted thereby preventing the entire device 10 falling into the engine housing 50. At the same time, the interior rear arms 25 contact the inner surface 52 of the same engine housing 50 and produce a force that opposes the force applied by the forward locking arms 20. The operation of the arms 20, 25 is such that the forward locking arms 20 apply pressure to the engine housing 50 in one direction while the interior rear arms 25 apply pressure to the same structure in an opposing direction thereby holding the shield 10 in place from two different directions and preventing the shield 10 from being pushed into or pulled out of the opening of the engine housing 50 into which it is inserted. FIG. 4 also shows the hub assembly 16 into which each of the arms 20, 25 inserts. The hub assembly 16 contains the structures that move the arms 20, 25 into and out of position as the shield 10 is expanded and contracted.

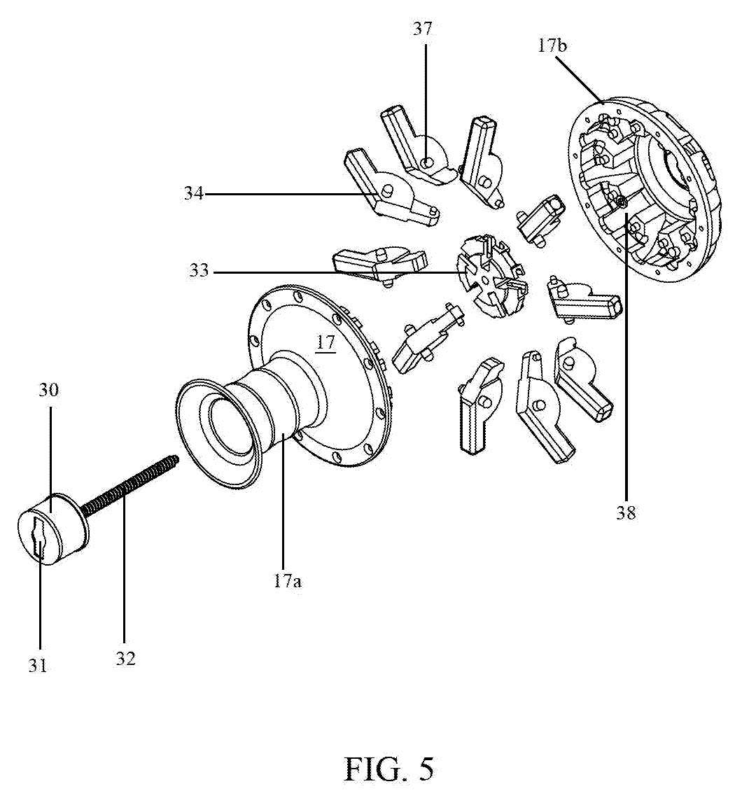

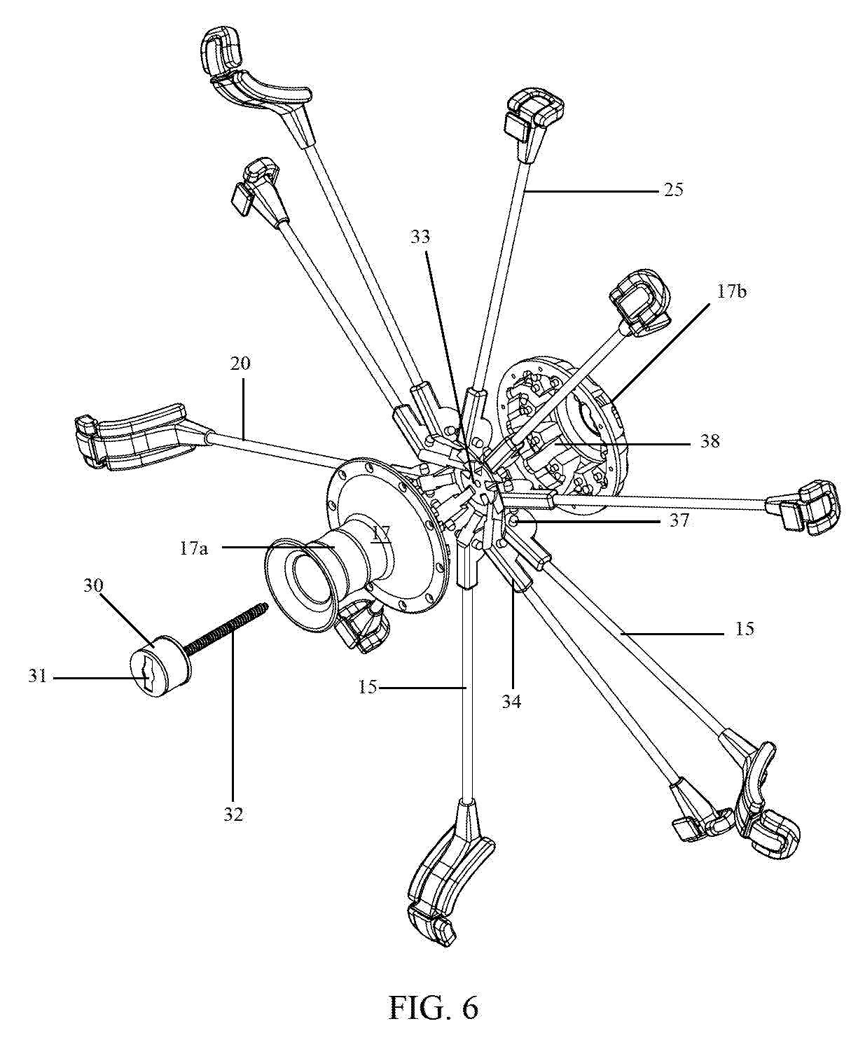

FIG. 5 shows an exploded view of the shield 10 with the cover removed. FIG. 6 is another exploded view of the same embodiment shown in FIG. 5 but also shows both the forward locking arms 20 and the interior rear arms 25 attached to the hub assembly 16. The shield 10 includes a hub assembly 16 that houses a number of the moving parts of the shield 10. The hub assembly 16 is made of a casing 17 that has a front or upper section 17a and a back or rear section 17b. The front section 17a of the casing 17 accommodates the installation port assembly 30 discussed in more detail below. The port 31 is an opening in a cylindrical structure that operably connects the port 31 to the drive screw 32 such that turning one causes the other to turn. The rear section of the casing 17 includes openings or locking arm sockets 38 through which the arms 20, 25 extend. Note, in FIG. 6, the locking arms are shown as being removed from the locking arm sockets 38 to better show them contacting the drive nut 33, the functioning of which is described below.

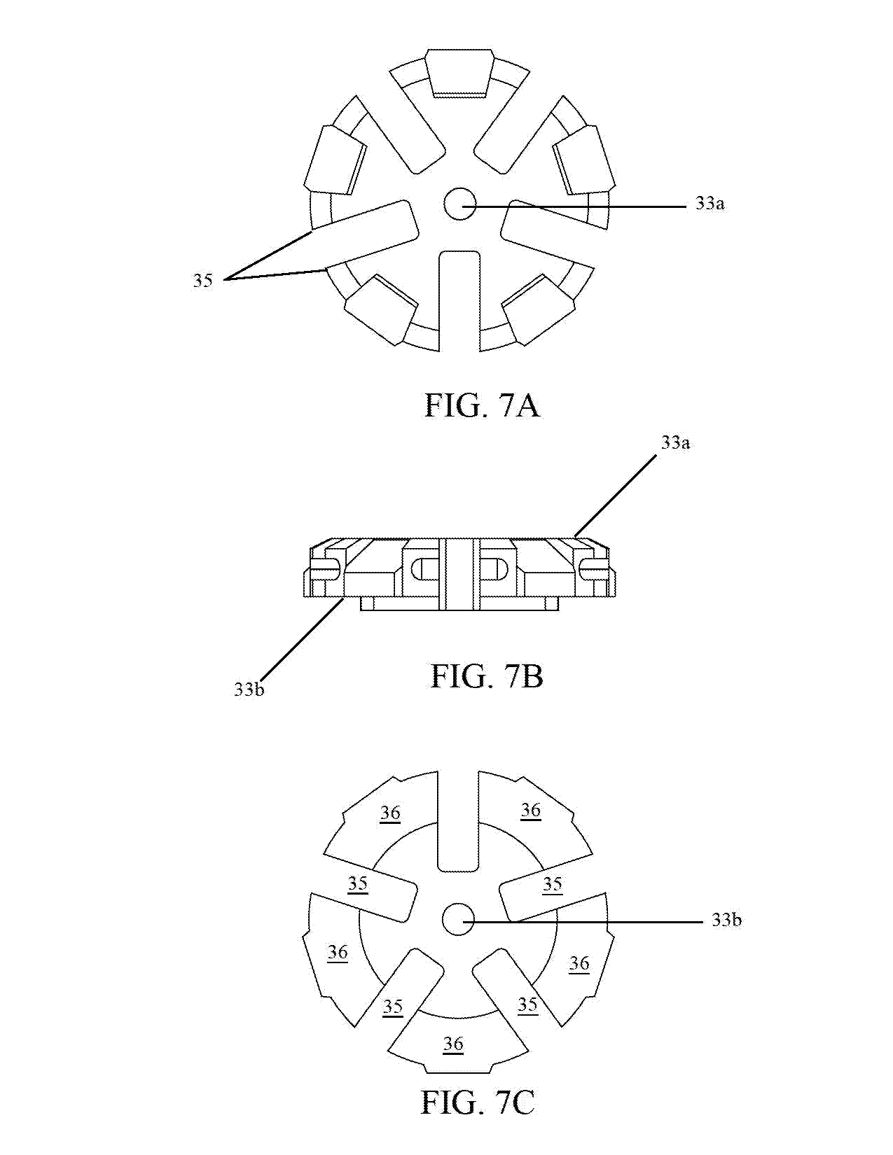

FIGS. 7A-7C, shows the drive nut 33 by itself. As discussed above, as the drive nut 33 moves up and down the length of the drive screw 32, the drive nut 33 moves the two sets of arms 20, 25, each of which engage with the drive nut 33 in a different manner. The drive nut 33 has an upper surface 33a that is closer to the installation port 31 than the lower surface 33b which faces and is closer to the rear section 17b of the casing 17. The drive nut 33 uses two different types of connection points to move the pivot points 34 attached to each arm 20, 25. One set of arms inserts into a slot 35 on the drive nut 33 and is pivotably connected to the drive nut 33 by a pin or protrusions on the arm that insert into both sides of the slot 35. The other set of arms engages with a drive arm exertion point 36 which is a flattened portion of the drive nut 33 located on the lower surface 33b of the drive nut 33. Because the drive nut 33 is not physically attached to the arms that engage the drive arm exertion point 36 the drive nut 33 can push those arms into place and keep turning, i.e. as it moves into a lowered position, the drive nut 33 pushes the first end 13 of each of the forward locking arms 20 into down into place, the arms do not block or arrest further movement of the drive nut 33, but rather the movement of the drive nut is arrested by a stop 18 located in the rear section 17b of the casing 17.

As show in in FIG. 5, each of the forward locking arms 20 and the interior rear arm 25 insert into the hub assembly 16 via locking arm sockets 38 that are openings in the hub casing 17 through which the arms 20, 25 pass. A middle portion 15 of each arm 20, 25 passes through this locking arm socket 38 and rests therein. Preferred embodiments of the arms 20, 25 include protrusions 37 that can fit into cavities or slots located in the locking arm sockets 38 thereby holding each arm 20, 25 in place and at the same time allowing the arms 20, 25 to pivot up and down in the locking arm socket 38. When the drive nut 33 moves downward along the length of the drive screw 32, away from the front section of the casing 17a (and the installation port 31) and further into the hub assembly 16, the pivot points 34 attached to each first end 13 of each arm 20, 25 are pushed downward by the drive nut 33 while the middle portion 15 of each arm pivots on/in the respective locking arm socket 38 thereby causing the second end 14 of each arm 20, 25 to lift upward in response. When the drive nut 33 is in a fully lowered position, the first end 13 and/or pivot points 34 of each arm 20, 25 are fully lowered and the second end of each arm 20, 25 is in a fully raised position. When the drive nut 33 is in a fully raised position, it does not exert pressure on the arms 20, 25 and the arms can be lowered.

Since the two types of arms are positioned differently with respect to the drive nut 33, the interior rear arms 25 can move while the forward locking arms 20 are locked in place. When turning the port, the drive nut 33 pushes the pivot point 34 attached to each forward locking arm 20 thereby extending those arms. The movement of the forward locking arms 20 is arrested by the rear portion 17b of the hub assembly casing 17 - the motion of the pivot points 34 is stopped when a middle portion of each arm 20 contacts the casing 17 adjacent to the locking arm socket 38 into which each arm is inserted. Because the pivot points 34 attached to the forward locking arms 20 are not physically attached to the drive nut 33, the drive nut 33 can push the forward locking arms 20 into place and continue to move downward along the drive screw 32 to continue pushing the interior rear arms 25 into place. This causes the two sets of arms to move at different rates, i.e. the forward locking arms 20 are locked in place while the interior rear arms continue to move until they contact an inner surface of the engine cowl.

In the preferred embodiment shown in FIGS. 5 and 6, the first end 13 of each of the arms 20, 25 terminates in a pivot point 34 which is a structure that controls how the arms move when the drive nut 33 is turned. The pivot point 34 can be a separate structure into which each arm 20, 25 inserts or it can be molded and integrated into the first end 13 of each arm 20. The pivot points 34 that are used with the interior rear arms 25 are connected to the drive nut 33 by being inserted into the slot 35 located in the body of the drive nut 33. Each of these pivot points 34 is fixed into the slot 35 via a traditional fastener that allows each interior rear arm 25 to pivot up and down with respect to the drive nut 33. In preferred embodiments, this fastener is either a pin that engages with the inner surface of a slot 35 on the drive nut 33, or a set of protrusions 37 on either side of the pivot point 34 that engages with the inner surface of the slot 35, thereby holding the pivot point 34 and thus the interior rear arm 25 in place while allowing it to pivot up and down with respect to the drive nut 33. A second of set of arms, the forward locking arms 20, are inserted into or otherwise attached to pivot points that are not physically attached or joined to the drive nut 33, but are positioned such that when the drive nut 33 moves downward toward the rear section 17b of the casing 17, each forward locking arm 20 encounters the drive arm exertion point 36.

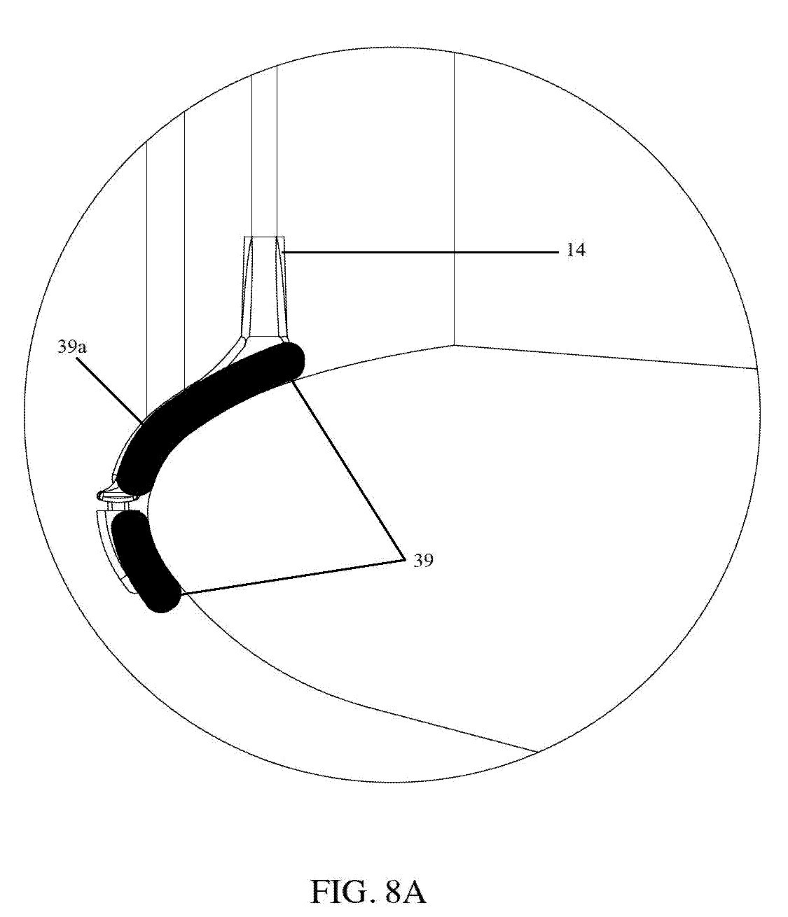

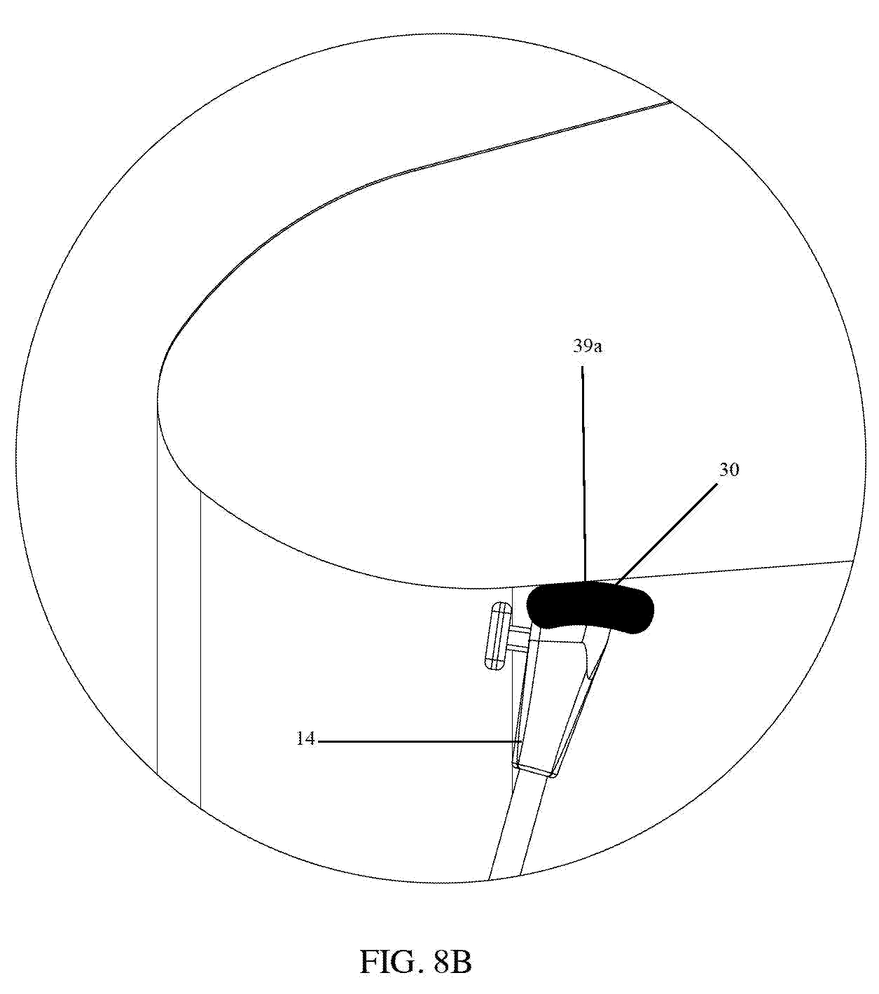

FIGS. 6, 8A and 8B show the retaining cap assembly 39 that is present at the second end 14 of each of the arms. Specifically, the retainer cap assembly 39 includes a pad 39a that fits over the second end 14 of each arm 20, 25. Preferred embodiments of the pad 39a include a two-piece structure that snaps together around or through a portion of the engine shield allowing the pads 39a to be locked in place without the use of other fasteners. The shape of each pad is dictated by the function of the device. The pads 39a that are located at the second ends 14 of the forward locking arms 20 are shaped to hug or contact the rounded exterior portion of the engine housing that is adjacent to the cavity or opening in said housing. In preferred embodiments, the pad is made of silicon, but it can be made of any durable, weather-proof non-abrasive material. The interior rear arms 25 also have a pad 39a attached to each of their respective second ends that is shaped differently. These pads 39a do not have to "grab" the entrance to the engine housing, but instead push against the inner surface of that housing. As a result, they are generally flatter than the pads 39a attached to the forward locking arms 20. The shield is self-centering in that when each set of arms is fully extended and contacts the engine housing, the shield is held in the center of the opening of the engine housing.

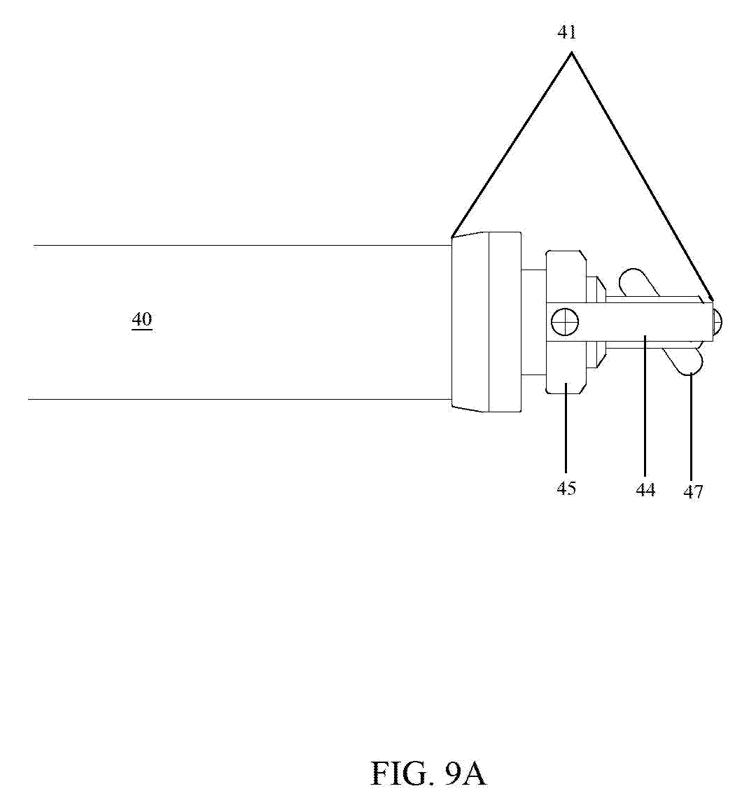

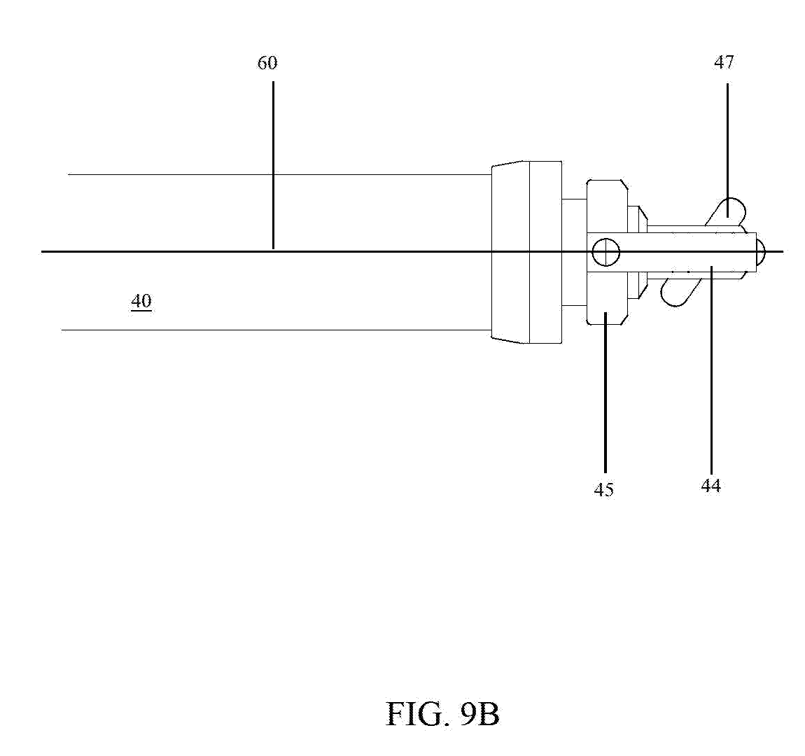

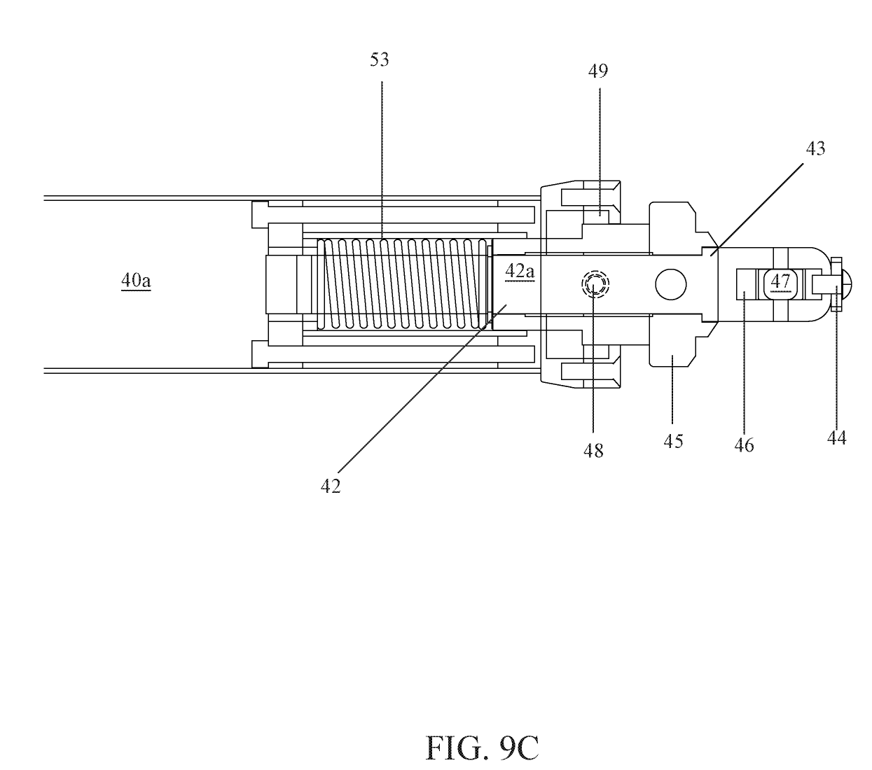

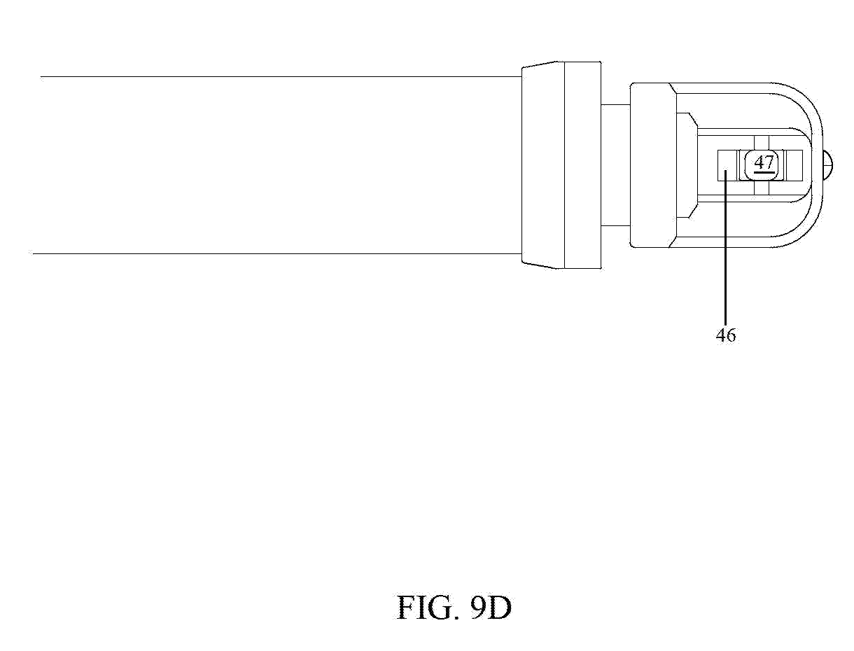

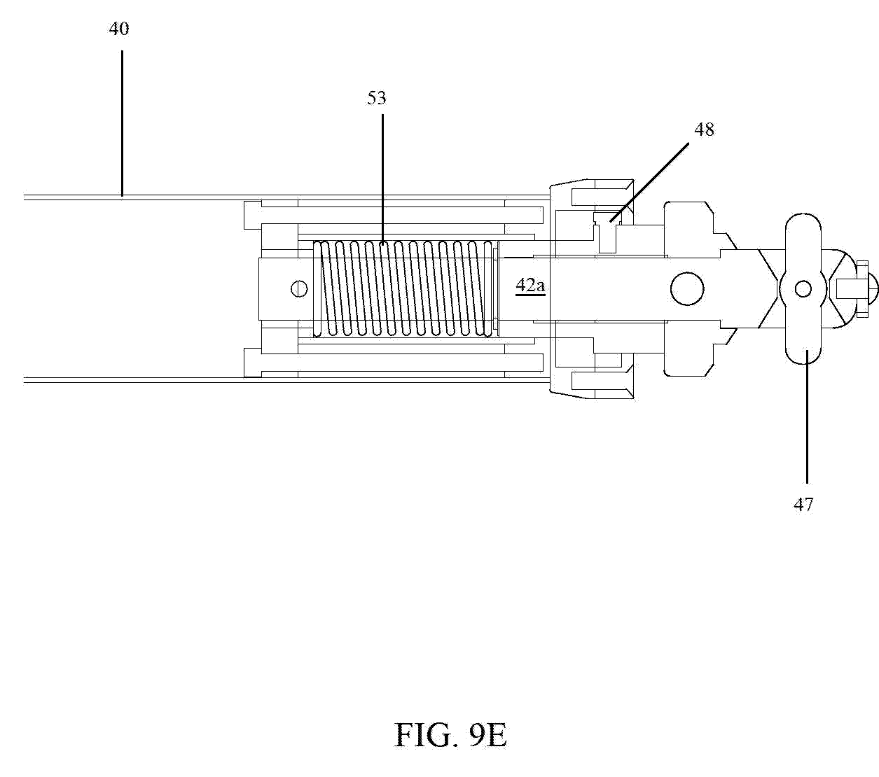

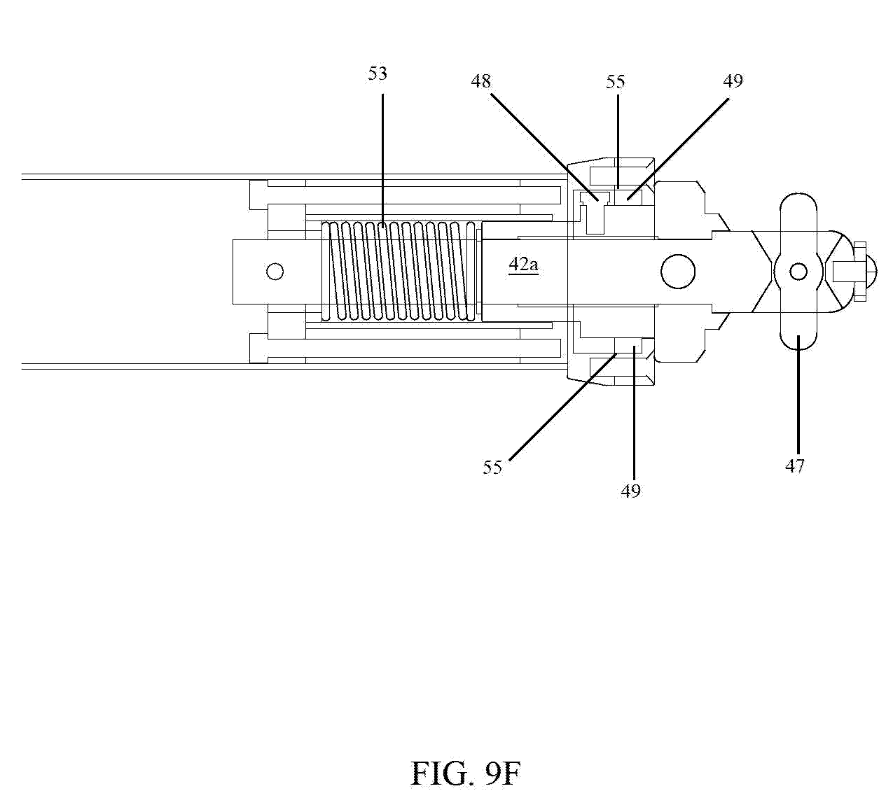

FIGS. 9A and 9B show a top view of the installation pole 40. FIG. 9C shows the same pole 40 with a cross-section cut along the longitudinal axis 60 of the installation pole 40. The installation pole 40 includes a locking pole end or head 41 that is seated in an opening (not shown) in the end of the installation pole 40. As shown in FIG. 9C, the head 41 includes an internal portion 42 and an external portion 43. The internal portion 42 turns or rotates with the rest of the installation pole 40. The external portion 43 of the head includes a locking ring 44 attached to a collar 45. In this embodiment, the locking ring 44 is an arc-shaped structure that is sized and shaped to fit into the installation port 31 and is rotatably fixed to the exterior portion 43 of the pole head 41 so that the external portion 43 and the locking ring 44 turn independently of the rest of the installation pole 40 when the pole 40 is rotated. The shape of the locking ring 44 is such that it has a horizontal surface to insert into the installation port 31 and the locking ring 44 extends downward to the collar 45 that is rotatably attached to the installation pole head 41. The embodiment shown in the figures is one possible shape for the locking ring 44, in essence it is important that the locking ring 44 be attached to the head 41 of the installation pole 40 and include a surface that is substantially horizontal to insert into the installation port 31 as described below.

FIGS. 9C and 9D show that the internal portion 42 of the head 41 includes a cavity 46 that holds the external locking pin 47. The external locking pin 47 is pivotably attached to the internal portion of the head and is positioned inside the cavity 46. Neither the locking ring 44 nor the head 41 of the installation pole pivot when the installation pole 40 is rotated, but rather the interior of the installation pole port 31 has enough extra room that the locking ring 44 can move around inside the port 31 as it is rotated at an angle to the installation pole port 31. The installation pole 40 is locked into the installation pole port 31 when the user rotates the pole and thereby rotates the locking ring 44 until the locking ring 44 and the external locking pin 47 are substantially perpendicular to each other. As the locking pole end 41 is rotated under the guidance of the user, the external locking pin 47 pivots up and down so as not to bind or arrest the movement of the locking pole end 41.

FIGS. 9E and 9F show the internal locking mechanism present in preferred embodiments and the inventors' anticipated best mode of the installation pole 40. This locking mechanism includes an internal locking pin 48 positioned on an outer, annual surface 42a of the internal portion of the head 41 that engages one or more locking grooves 49 located on an inner surface 40a of the installation pole 40 when the locking pole end 41 is rotated such that the locking pin 48 and the locking groove 49 are aligned. FIG. 9E shows the locking pin engaged in one of the locking grooves 49. FIG. 9F shows the same locking pin 48 disengaged from the same locking groove 49. The locking grooves 49 are substantially parallel to or in line with the longitudinal axis of the installation pole. Preferred embodiments of the installation pole 40 have more than one locking groove 49 such that the internal locking pin 48 can be inserted into more than one locking groove 49. One locking groove 49 may be positioned to lock the locking pole end 41 in place when it is rotated clockwise, another groove may be positioned to lock the locking pole head 41 in place when the installation pole 40 is rotated in the opposite direction and a third groove may accommodate the locking pin 48 when the locking ring 44 and external locking pin 47 are aligned in a "neutral" position. In preferred embodiments and the inventors' anticipated best mode, the installation pole 40 has three locking grooves 49 into which the locking pin 48 is pushed by an internal spring 53. The installation lock point and the removal lock point are 180 degrees from one another with the neutral lock point being between the two at 90 degrees from either. The neutral position is also the position in which the installation pole can be inserted into and taken out of the installation port. The other two positions represent positions in which the locking ring is rotated to turn the installation port 31 to either expand or raise the arms 20, 25 or to contract them for removal and storage.

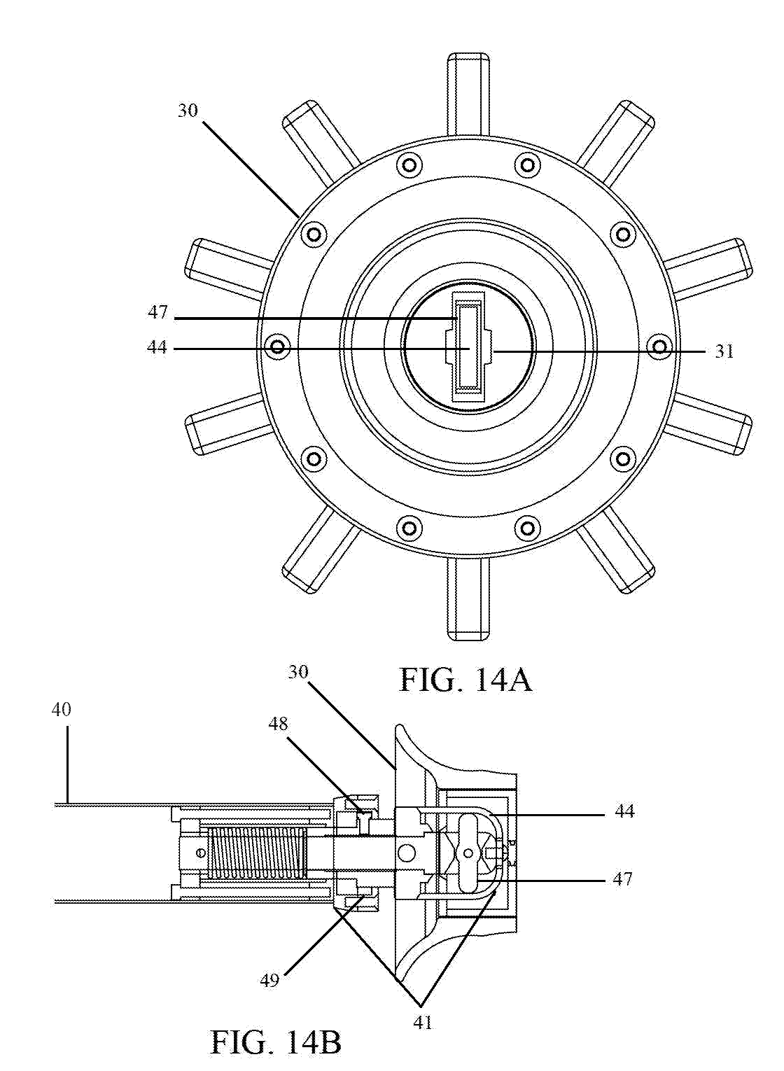

The procedure for installing the engine shield 10 into an aircraft engine inlet is as follows. The user holds the engine shield 10 in one hand and the installation pole 40 in the other. At this point, the installation pole is in a "neutral", locked position (See FIG. 14B) for insertion into the installation pole port 31 which is to say the locking pole head 41 is locked in position by the internal locking pin 48 being inserted into one of the locking grooves 49 - the neutral locking groove. When in the neutral position, the horizontal section of the locking ring 44 and the external locking pin 47 are aligned, i.e. substantially parallel to each other.

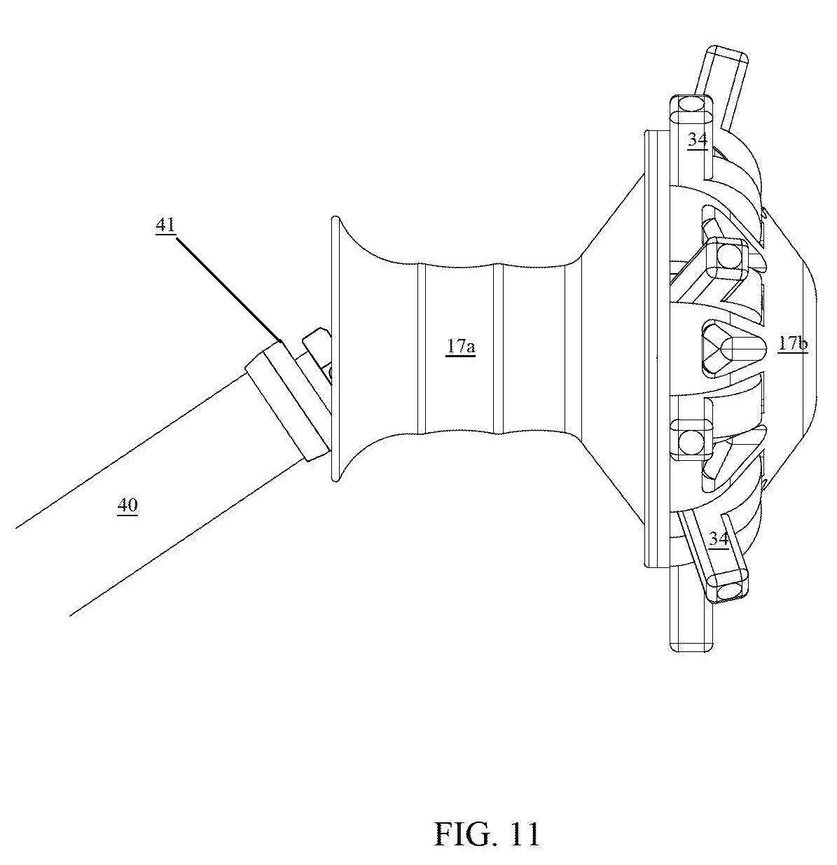

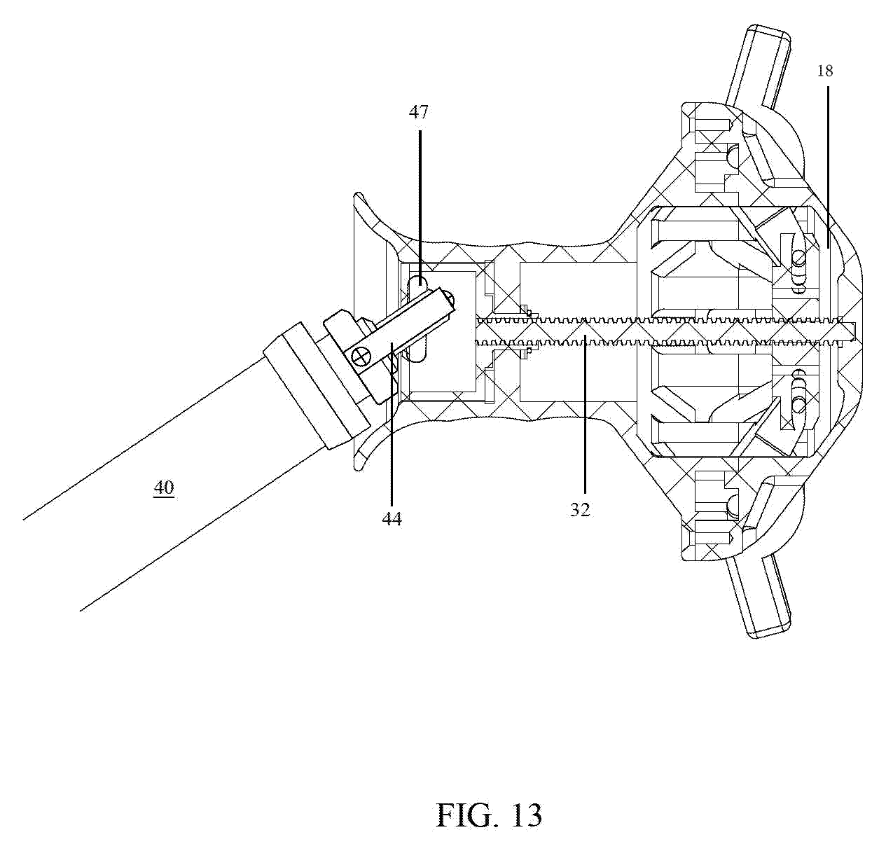

With the installation pole head 41 in the neutral position, the user inserts the installation pole end 41 with the locking ring 44 and external locking pin 47 into the installation pole port 31 on the engine shield 10 (see FIGS. 11 and 13) and pushes to compress the internal spring 53 and release the internal locking pin 48 from the neutral locking groove 49. At either extreme, full clockwise or full counterclockwise rotation, the internal locking pin 48 contacts an internal stop point that lines up with another locking groove 49. At these stop points 55 if the user releases the pushing pressure on the pole the internal spring 53 will push the internal locking pin 48 into a locking groove 49 at either the installation or removal position. Even if the user continues to push the installation pole head 41 and compress the internal spring 53, the internal stop still arrests the rotation of pole head 41 and installation pole 40 and allows the user to rotate the installation pole port 31 to install or remove the engine shield 10. With the pole head 41 inserted into the installation pole port 31, the user then rotates the installation pole 40 in one direction (clockwise in this example), causing the internal portion 42 of the installation pole head 41 with the external locking pin 47 attached to rotate with the pole 40. Because the locking ring 44 and the collar 45 to which it is attached are rotatably mounted to the installation pole 40 and have been inserted into the installation pole port 31, the internal portion of the pole head 41 turns with the pole while the locking ring 44 does not. The turning of the installation pole causes the pole 40 to rotate while the locking ring 44 is held in place in the port 31. The result of this rotation is that the locking ring 44 and the external locking pin 47 are substantially perpendicular to each other. The engine shield 10 is now locked onto the installation pole 40 and the user can let go of the engine shield 10 and support the engine shield 10 and the installation pole 40 with two hands on the installation pole 40. When the user stops applying forward pressure to the installation pole 40, the spring 53 inside the installation pole 40 is no longer compressed and the internal spring 53 pushes the internal locking pin 48 into the installation locking groove 49, securing the engine shield hub assembly 16 to the installation pole end 41. This allows the user to safely transport the engine shield to the engine of the aircraft avoiding damage to equipment and injury to other employees.

Next the user rotates the installation pole 40 clockwise to turn the installation port 31 and expand the engine shield 10 until the forward locking arms 20 are fully extended. The interior rear arms 25 are also extended but not to the point of being too large to insert into the engine inlet.

The user then positions the engine shield 10 over the jet engine inlet and pushes on the installation pole 40 to ensure a tight fit to the engine. This pushing motion compresses the internal spring 53 and releases the internal locking pin 48 from the installation locking groove 49. After the installation pole is rotated, the internal locking pin 48 sits against an internal stop point 55 allowing the user to rotate the installation pole 40 clockwise applying a rotating force to the installation port 31 and causing the arms 20, 25 to move. When the user releases pressure on the installation pole 40 the internal spring 53 pushes the internal locking pin 48 back into the installation locking groove 49 provided that the user has not rotated the pole in the opposite direction. Note, FIG. 13 also shows the orientation of the installation pole head 41 when inserted into the installation pole port 31. There is enough extra space in the inside of the installation port 31 that the installation pole head 41 can move and rotate while inserted at an angle to the longitudinal axis of the hub assembly 16 (also the longitudinal axis of the drive screw 32).

After installation is complete, the user pushes on the installation pole to compress the internal spring 53 and release the internal locking pin 48 from the installation locking groove 49. The user rotates the installation pole 40 slightly in the opposite direction from installation rotation to move the internal locking pin 48 away from its locking groove and towards the neutral locking groove 49. The user stops applying any pushing pressure on the installation pole to allow the internal spring 53 to drive the internal locking pin 48 into the neutral locking groove 49. Once the user feels the internal locking pin 48 slip into the release lock groove 49 the installation pole 40 can be removed from the port 31.

The procedure for removal of the engine shield is as follows. First, the user ensures the installation pole end 41 is in neutral, locked position. Next, the user inserts the installation pole end 41 into the installation pole port 31 and pushes the pole to release the internal locking pin 48 from its neutral locking groove 49 at the neutral position. The removal direction or direction the installation pole is turned when uninstalling the shield 10 is opposite the direction used for installation. As a result, in this example, the user rotates the installation pole 40 counterclockwise until the internal locking pin 48 meets the internal stop point 55. When the user continues pushing on the installation pole 40 the internal locking pin 48 pushes against the internal stop point 55 and thereby turns the installation pole port 31 relieving the tension or pressure holding the arms in place allowing the user to retract the arms 20, 25 of the engine shield 10 enough to remove it from the engine inlet. At that time the natural movement of pulling the pole will allow the internal spring 53 to push the internal pin into a third or removal locking groove 49 for safe transport of the engine shield 10 over the wing. When the user stops pushing on the installation pole after insertion into the installation pole port 31, then the internal spring 53 will push the internal lock pin into the removal locking groove. The user then rotates the installation pole 40 counterclockwise to unlock the engine shield from the engine inlet. Once unlocked the user moves the engine shield away from the engine and to an open space away from the aircraft.

Once the engine shield is free from the aircraft the user continues to rotate counterclockwise to fully close the engine shield. The user applies the security band to hold the engine shield closed.

The user then pushes on the pole head to release the internal locking pin and rotate the pole head slightly in the direction opposite from the previous procedure. The user then releases pushing pressure and allows the internal spring 53 to push the internal lock pin 48 into the neutral locking groove 49. The pole end is now unlocked from the engine shield hub and can be removed. The user then prepares the engine shield and pole for storage. The installation pole can be made in sections such that it telescopes and retracts or compresses into a smaller unit for easy storage. The arms of the engine shield 10 also retract toward the hub assembly for storage as well.

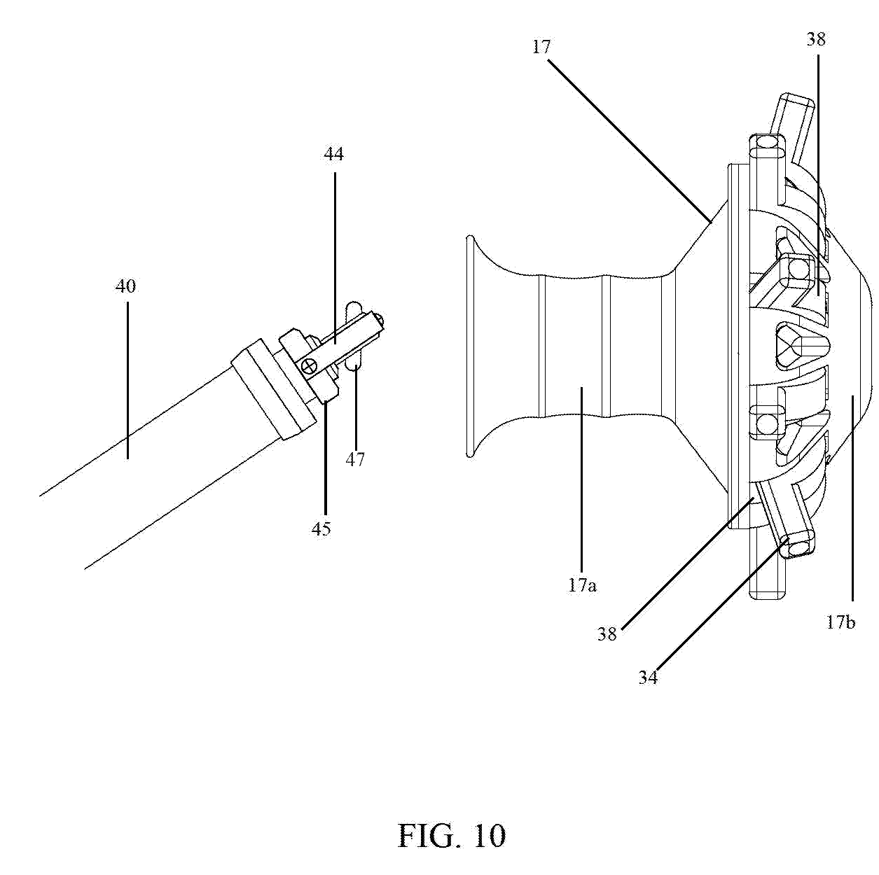

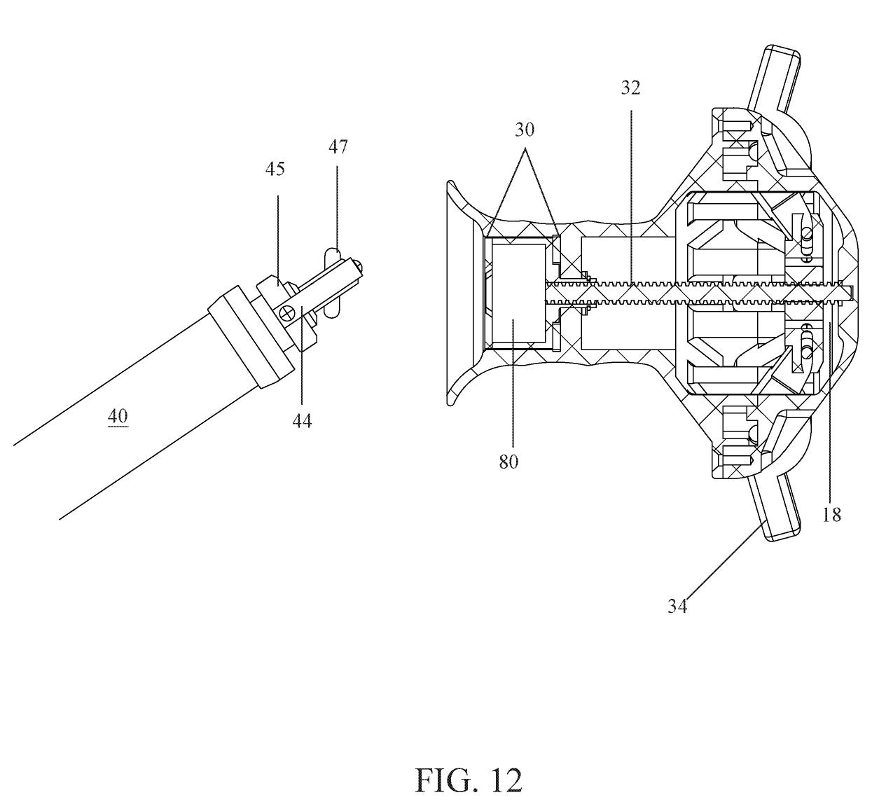

FIGS. 10-13 show the installation pole 40 being inserted into the installation pole port. For convenience, the external locking pin 47 is not aligned with the locking ring 44 as would be the case when the installation pole 40 is first inserted into installation pole port. As can be seen in FIGS. 11 and 13, the installation pole 40 is designed to be able to insert into the installation pole port 31 at an angle of up to 35 degrees (with respect to the longitudinal axis of the hub assembly). This configuration allows a user to install the engine shield 10 from the ground rather than having to climb a ladder to reach the engine inlet.

FIG. 13 in particular shows the manner in which the installation pole 40 interacts with the installation pole port 31 and associated hub. This figure shows the locking ring 44 and the external locking pin 47 "locked" in place, i.e. the external locking pin 47 is positioned such that it is substantially perpendicular to the locking ring 44. The installation pole head 41 with the locking ring 44 and external locking pin 47 has been inserted into the port 31 at an angle to the longitudinal axis of the hub assembly (presumably at an angle to the ground as well). One can think of the longitudinal axis of the drive screw as being the same as the longitudinal axis of the hub assembly for the purposes of this disclosure. An interior of the installation pole port 31 has space therein to accommodate the installation pole head 41 inserted at that angle and to allow it to rotate. Moreover, the external locking pin 47 is forced to pivot up and down as the installation pole head is rotated inside the port 31. This pivoting motion prevents the external locking pin 47 from binding or becoming stuck inside the port 31 and preventing further rotation.

FIGS. 14A and 14B show the hub assembly 16 including the installation pole port 31 as well as the head of the installation pole 40 in neutral position. 14B shows the locking pin 48 inserted into the neutral locking groove 49, i.e. the position in which the locking ring 44 and the external locking pin 47 are substantially parallel to each other. FIG. 14A shows the shape of the installation port 31 which is complementary to the pole head 41 when it is in neutral position.

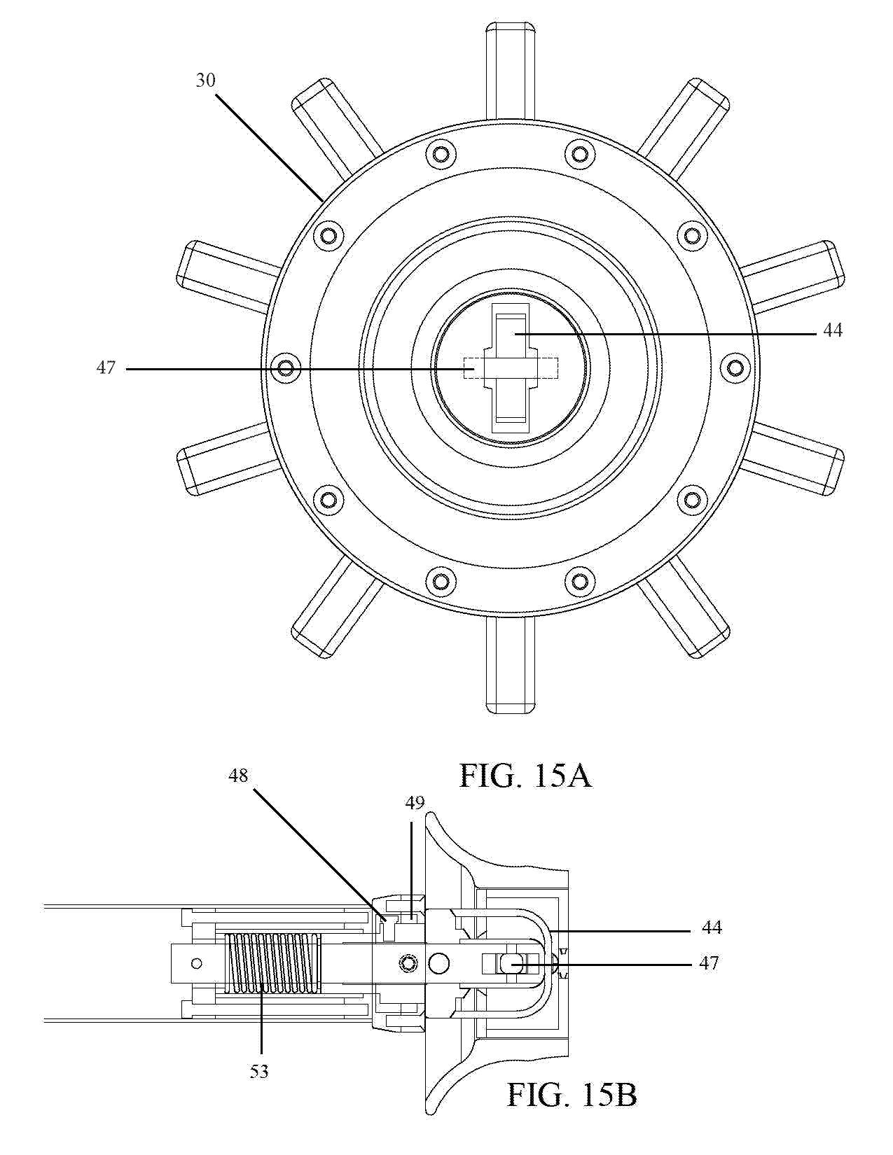

FIGS. 15A and 15B show the same installation pole 40 in an installation or removal position. When the spring 53 in the installation pole 40 is compressed, the locking pin 48 is forced out of its locking pin groove 49 and the user turns the installation pole 40, with the locking ring inserted into the port 31, the rest of the installation pole 40 rotates accordingly, including the inner section of the pole head 41 that includes the external locking pin. This rotation turns the locking pin such that it is substantially perpendicular to the portion of the locking ring 44 inserted into the port 31. With the external locking pin 47 at approximately 90 degrees to the locking ring 44, the installation pole is locked into place and the user can use it to move the engine shield.

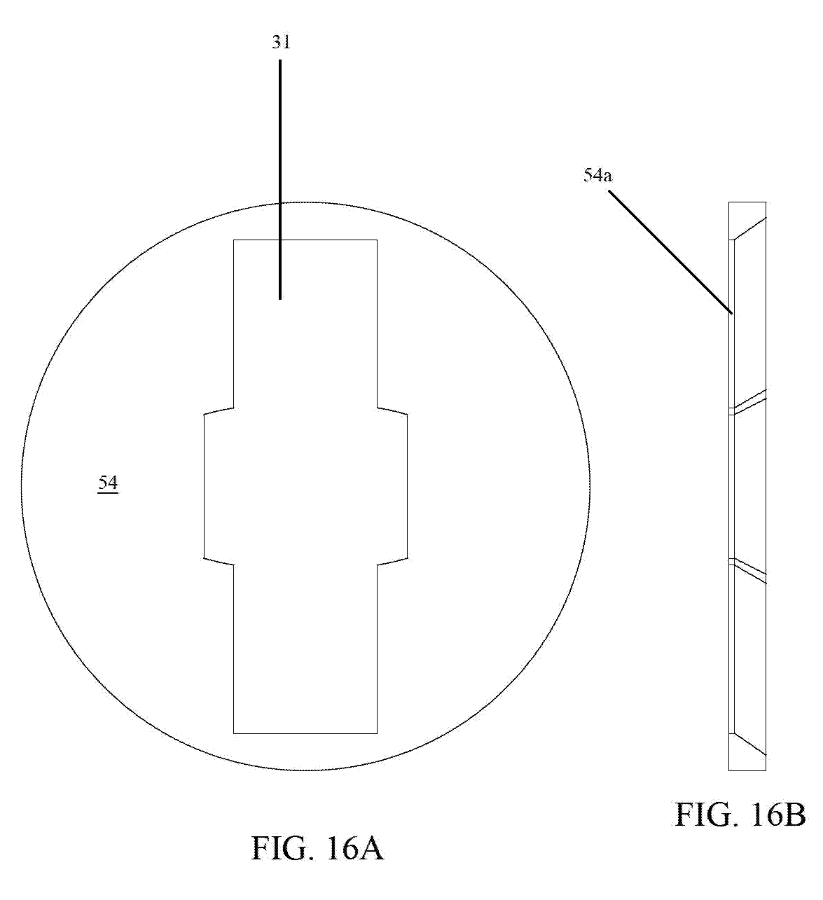

As shown in FIGS. 16A and 16B, in preferred embodiments, the inner surface of the installation port that surrounds the opening into which the locking ring 44 and external locking pin 47 insert is beveled to make it easier for the locking ring 44 and the external locking pin 47 to rotate. When the user inserts the installation pole head 41 into the installation pole port 31 at an angle, the beveled surface 54a on the inside of the installation pole port face 54 allows the locking ring 44 to rotate inside the installation pole 40 when inserted at an angle.

### Industrial Applicability

In broad terms, the presently disclosed device is a safety device for use with aircraft, namely a mechanized shield for an aircraft opening. More particularly, the present invention is in the field of covers or shields used to protect sensitive aircraft equipment.

The advantages of the present invention include, without limitation, the ability to block, cover or shield an opening in an aircraft body without risking damage to the delicate leading edges or inner surfaces of the same opening. The aircraft shield is held in place by two sets of arms that produce opposing forces making it difficult to pull the shield out of the engine or push it into the engine cavity. Another advantage of the disclosed shield and tool is that it can be installed and removed from the aircraft by a crewmember standing on the ground. The installation pole allows for easy installation and removal of the engine shield by a single individual. The device is also resistant to the cleaning agents that are typically used to clean the exteriors of the aircraft allowing them to be left in place during cleaning.

Furthermore, the described features, advantages, and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

It is understood that the above-described embodiments are only illustrative of the application of the principles of the present invention. The present invention may be embodied in other specific forms without departing from its spirit or essential characteristics. The described embodiment, including the best mode, is to be considered in all respects only as illustrative and not restrictive. The scope of the invention is, therefore, indicated by the appended claims, if any, in conjunction with the foregoing description.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention.

We claim:

1. A tool for installing a piece of ground support equipment onto an aircraft; said tool comprising:
a pole with a locking head; said locking head comprising:
an external portion that includes a locking ring attached to a collar wherein said collar is rotatably attached to the pole head and rotates independently of the rest of the pole; and
an internal portion that is fixed to the pole and rotates when the pole is rotated around a longitudinal axis.

2. The tool of claim 1 wherein the internal portion of the locking head comprises an external locking pin that is positioned in a cavity and is pivotably attached to the internal portion of the locking head.

3. The tool of claim 2 further comprising at least one internal locking groove located on an inner surface of the pole and at least one locking pin located on an outer surface of the internal portion of the locking head wherein the insertion of the at least one locking pin into the at least one locking groove arrests the rotation of the locking head in at least one direction.

4. The tool of claim 3 wherein the at least one locking groove comprises three locking grooves located on the inner surface of the pole wherein the insertion of the locking pin into one of the at least three locking grooves arrests the rotation of the locking head in at least one
direction.

5. The tool of claim 4 wherein the three locking grooves comprise:
a first locking groove positioned on the outer surface of the internal portion of the locking head;
a second locking groove located on the outer surface of the internal portion of the locking head positioned 180 degrees away from the first locking groove; and
a third locking groove located on the outer surface of the internal portion of the locking head between the first locking groove and the second locking groove.

6. The tool of claim 5 wherein the locking ring and the external locking pin are aligned when the locking pin is inserted into the third locking groove.

7. The system of claim 6 further comprising a spring positioned on the outer surface of the internal portion of the locking head; wherein said spring applies force to the at least one locking to move said at least one locking pin out of one of the three locking grooves when the spring is compressed and pushes the locking pin into one of the three locking grooves when the spring is not compressed and the at least one locking pin is aligned with one of the three locking grooves.

8. The tool of claim 3 further comprising at least one internal stop position adjacent to the at least one locking groove.

9. The tool of claim 5 further comprising an internal stop positioned adjacent to each of the three locking grooves.

10. The tool of claim 7 further comprising an internal stop positioned adjacent to each of the three locking grooves.

11. A method of using the tool of claim 10 to install a piece of ground support equipment onto an aircraft comprising:
turning the locking head until the at least one locking pin is aligned with the third locking groove;
releasing pressure on the locking head and spring such that the spring pushes the at least one
locking pin into the third locking groove;
inserting the locking ring into the piece of ground support equipment;
positioning the piece of ground support equipment in a desired location;
applying pressure to the spring to force the at least one locking pin out of the third locking groove;
turning the pole clockwise or counter-clockwise until the at least one internal locking pin contacts the internal stop positioned adjacent to either the first locking groove or the second locking groove;
releasing pressure on the spring to allow the at least one locking pin to insert into either the first or second locking groove; and
continuing to rotate the pole.
